(19) United States
(12) Patent Application Publication
(10) Pub. No.: US 2026/0023244 A1
(43) Pub. Date: Jan. 22, 2026

(54) OPTICAL IMAGING LENS

(71) Applicant: Calin Technology Co., Ltd., Taichung City (TW)

(72) Inventors: FUN-RU LIN, Taichung City (TW); SHU-CHUAN HSU, Taichung City (TW); YUE-JHANG LI, Taichung City (TW)

(73) Assignee: Calin Technology Co., Ltd., Taichung City (TW)

(21) Appl. No.: 18/939,511

(22) Filed: Nov. 6, 2024

(30) Foreign Application Priority Data
Jul. 18, 2024 (TW) 113126831

(51) Int. Cl. G02B 13/00; G02B 9/64

(52) U.S. Cl. CPC G02B 13/0045; G02B 9/64

(57) ABSTRACT

An optical imaging lens, in order from an object side to an image side along an optical axis, includes a first lens assembly, an aperture, and a second lens assembly. The first lens assembly consists of, in order from the object side to the image side along the optical axis, a first lens having negative refractive power and a second lens having positive refractive power. An object-side surface of the first lens is concave. An image-side surface of the first lens is convex. The second lens assembly consists of, in order from the object side to the image side along the optical axis, a third lens having negative refractive power, a fourth lens having positive refractive power, and a fifth lens having negative refractive power. An object-side surface of the fifth lens is concave. An image-side surface of the fifth lens is convex.

### BACKGROUND OF THE INVENTION

### Technical Field

The present invention generally relates to an optical image capturing system, and more particularly to an optical imaging lens, which provides a better optical performance of low distortion and high image quality.

### Description of Related Art

In recent years, with advancements in portable electronic devices having camera functionalities, the demand for an optical image capturing system is raised gradually. The ordinary optical image capturing system is commonly selected from a charge-coupled device (CCD) or a complementary metal-oxide-semiconductor sensor (CMOS Sensor). Besides, as advanced semiconductor manufacturing technology enables the minimization of the pixel size of the image sensing device, the development of the optical image capturing system towards the field of high pixels. Moreover, with the advancement in drones and driverless autonomous vehicles, Advanced Driver Assistance System (ADAS) plays an important role in the field of vehicle safety and collects real-time environmental information through various lenses and sensors to provide the comprehensive insights of the driver. Furthermore, as the automotive lens changes with the temperature of an external application environment, the temperature requirements of the image quality of the automotive lens also increase. Therefore, the requirement for high imaging quality is rapidly raised.

Good imaging lenses generally have the advantages of low distortion, high resolution, etc. In practice, small size and cost must be considered. Therefore, it is a big problem for designers to design a lens with good imaging quality under various constraints.

### BRIEF SUMMARY OF THE INVENTION

In view of the reasons mentioned above, the primary objective of the present invention is to provide an optical imaging lens that provides high image quality.

The present invention provides an optical imaging lens, in order from an object side to an image side along an optical axis, including a first lens assembly, an aperture, and a second lens assembly, wherein the first lens assembly consists of, in order from the object side to the image side along the optical axis, a first lens and a second lens. The first lens has negative refractive power. An object-side surface of the first lens is a concave surface. An image-side surface of the first lens is a convex surface. The second lens has positive refractive power. The second lens assembly consists of, in order from the object side to the image side along the optical axis, a third lens, a fourth lens, and a fifth lens. The third lens has negative refractive power. The fourth lens has positive refractive power. The fifth lens has negative refractive power. An object-side surface of the fifth lens is a concave surface. An image-side surface of the fifth lens is a convex surface.

The effect of the present invention lies in arranging at least five lenses into an optical assembly for the optical imaging lens. In addition, the arrangement of the refractive powers and the conditions of the optical imaging lens of the present invention could achieve the effect of high image quality.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1A is a schematic view of the optical imaging lens according to a first embodiment of the present invention;

FIG. 1B is a diagram showing the longitudinal chromatic aberration of the optical imaging lens according to the first embodiment of the present invention;

FIG. 1C is a diagram showing the lateral chromatic aberration of the optical imaging lens according to the first embodiment of the present invention;

FIG. 2A is a schematic view of the optical imaging lens according to a second embodiment of the present invention;

FIG. 2B is a diagram showing the longitudinal chromatic aberration of the optical imaging lens according to the second embodiment of the present invention;

FIG. 2C is a diagram showing the lateral chromatic aberration of the optical imaging lens according to the second embodiment of the present invention;

FIG. 3A is a schematic view of the optical imaging lens according to a third embodiment of the present invention;

FIG. 3B is a diagram showing the longitudinal chromatic aberration of the optical imaging lens according to the third embodiment of the present invention; and

FIG. 3C is a diagram showing the lateral chromatic aberration of the optical imaging lens according to the third embodiment of the present invention.

### DETAILED DESCRIPTION OF THE INVENTION

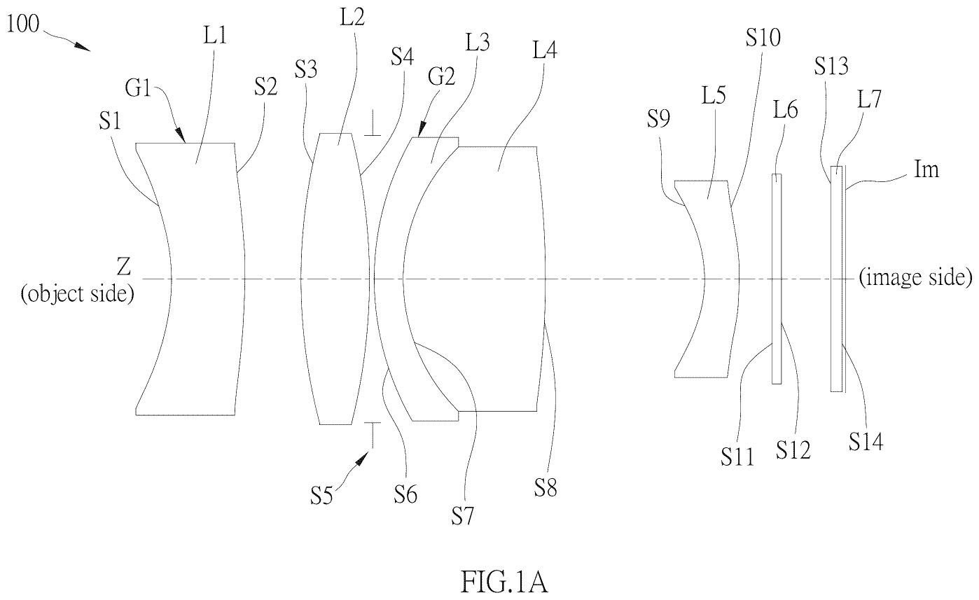

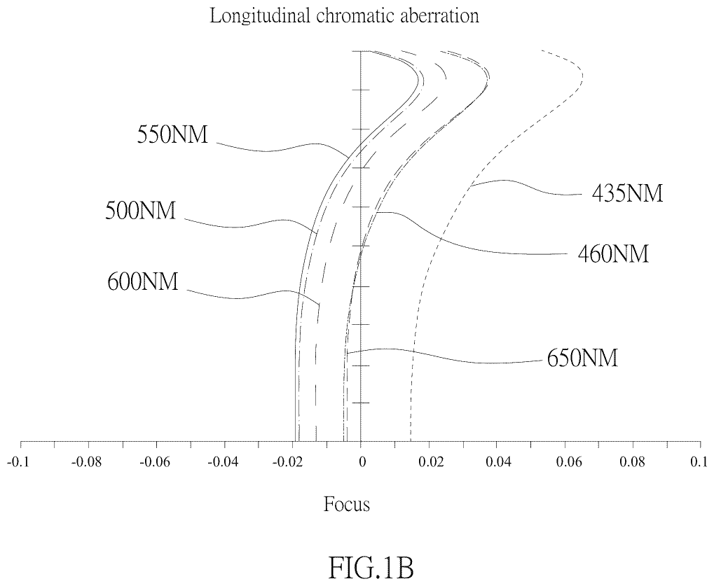

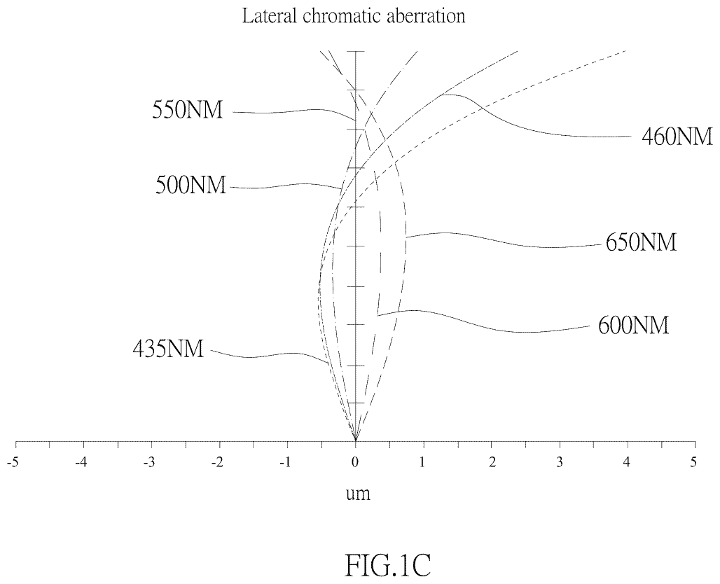

An optical imaging lens 100 according to a first embodiment of the present invention is illustrated in FIG. 1A, which includes, in order along an optical axis Z from an object side to an image side, a first lens assembly G1, an aperture S5, and a second lens assembly G2. In the first embodiment, the optical imaging lens 100 includes at least five lenses, wherein the first lens assembly G1 consists of, in order along the optical axis Z from the object side to the image side, a first lens L1 and a second lens L2. The second lens assembly G2 consists of, in order along the optical axis Z from the object side to the image side, a third lens L3, a fourth lens LA, and a fifth lens L5, wherein the first lens L1, the second lens L2, and the fifth lens L5 are single lenses, which means an air space is provided between the first lens L1 and the second lens L2 along the optical axis Z, an air space is provided between the second lens L2 and the third lens L3 along the optical axis Z, and an air space is provided between the fourth lens LA and the fifth lens L5 along the optical axis Z. The third lens L3 and the fourth lens LA are adhered to form a compound lens.

The first lens L1 has negative refractive power. An object-side surface S1 of the first lens L1 is a concave surface. An image-side surface S2 of the first lens L1 is a convex surface. In the current embodiment, both of the object-side surface S1 of the first lens L1 and the image-side surface S2 of the first lens L1 are aspheric surfaces.

The second lens L2 is a biconvex lens with positive refractive power. In the current embodiment, both of an object-side surface S3 of the second lens L2 and an image-side surface S4 of the second lens L2 are spherical surfaces.

The third lens L3 has negative refractive power. An object-side surface S6 of the third lens L3 is a convex surface. An image-side surface S7 of the third lens L3 is a concave surface. In the current embodiment, both of the object-side surface S6 of the third lens L3 and the image-side surface S7 of the third lens L3 are spherical surfaces.

The fourth lens LA is a biconvex lens with positive refractive power. Both of an object-side surface S7 of the fourth lens LA and an image-side surface S8 of the fourth lens L4 are spherical surfaces. In the current embodiment, the image-side surface S7 of the third lens L3 and the object-side surface S7 of the fourth lens LA are correspondingly adhered, so that the third lens L3 and the fourth lens LA are combined to form the compound lens with positive refractive power.

The fifth lens L5 has negative refractive power. An object-side surface S9 of the fifth lens L5 is a concave surface. An image-side surface S10 of the fifth lens L5 is a convex surface. In the current embodiment, both of the object-side surface S9 of the fifth lens L5 and the image-side surface S10 of the fifth lens L5 are aspheric surfaces.

Additionally, the optical imaging lens 100 further includes an infrared filter L6 and a protective glass L7, wherein the infrared filter L6 forms an object-side surface S11 facing the object side and an image-side surface S12 facing the image side. The infrared filter L6 is disposed on a side of the image-side surface S10 of the fifth lens L5, thereby restricting infrared rays passing through the optical imaging lens 100 to improve the quality and fidelity of the image. The protective glass L7 forms an object-side surface S13 facing the object side and an image-side surface S14 facing the image side. The protective glass L7 is disposed on a side of the infrared filter L6 and is located between the infrared filter L6 and an image plane Im, thereby protecting the infrared filter L6.

In order to keep the optical imaging lens 100 in good optical performance and high imaging quality, in the first embodiment, the optical imaging lens 100 further satisfies:

$$- 17.00 < F / ( f 1 + f 2 ) < - 12 \text{.00} ; \qquad ( 1 )$$

$$- 0.5 < F / ( f 3 + f 4 + f 5 ) < - 0.3 ; \qquad ( 2 )$$

$$- 0.76 < F / f 1 < - 0.73 ; \qquad ( 3 )$$

$$0.78 \leq F / f 2 < 0.8 ; \qquad ( 4 )$$

$$- 0.49 < F / f 3 < - 0.46 ; \qquad ( 5 )$$

$$1.3 < F / f 4 < 1 \text{.35} ; \qquad ( 6 )$$

$$- 0.89 < F / f 5 < - 0.83 ; \qquad ( 7 )$$

$$- 0.8 < fg 2 / ( R 1 + R 2 + R 3 + R 4 + R 6 + R 7 + R 8 + R 9 + R 10 ) < - 0. 30 ; \qquad ( 8 )$$

$$- 1.5 < fg 2 / ( R 6 + R 7 + R 8 + R 9 + R 10 ) < - 0. 80 ; \qquad ( 9 )$$

$$- 0.8 < fg 1 / ( R 1 + R 2 + R 3 + R 4 + R 6 + R 7 + R 8 + R 9 + R 10 ) < - 0. 60 ; \qquad ( 10 )$$

$$- 1.6 < fg 1 / ( R 1 + R 2 + R 3 + R 4 ) < - 1. 50 ; \qquad ( 11 )$$

$$- 2. < F / R 1 < - 1.5 ; \qquad ( 12 )$$

$$- 0.8 < F / R 2 < - 0.6 ; \qquad ( 13 )$$

$$0.55 < F / R 3 < 0.65 ; \qquad ( 14 )$$

$$- 0.7 < F / R 4 < - 0.55 ; \qquad ( 15 )$$

$$1. < F / R 6 < 1.6 ; \qquad ( 16 )$$

$$1.9 < F / R 7 < 2. ; \qquad ( 17 )$$

$$- 0.45 < F / R 8 < - 0.35 ; \qquad ( 18 )$$

$$- 2.95 < F / R 9 < - 2.75 ; \qquad ( 19 )$$

$$- 1.5 < F / R 10 < - 1.4 ; \qquad ( 20 )$$

wherein F is a focal length of the optical imaging lens 100; f1 is a focal length of the first lens L1; f2 is a focal length of the second lens L2; f3 is a focal length of the third lens L3; f4 is a focal length of the fourth lens L4; f5 is a focal length of the fifth lens L5; fg1 is a focal length of the first lens assembly G1; fg2 is a focal length of the second lens assembly G2; R1 is a radius of curvature of the object-side surface S1 of the first lens L1; R2 is a radius of curvature of the image-side surface S2 of the first lens L1; R3 is a radius of curvature of the object-side surface S3 of the second lens L2; R4 is a radius of curvature of the image-side surface S4 of the second lens L2; R6 is a radius of curvature of the object-side surface S6 of the third lens L3; R7 is a common radius of curvature of the image-side surface S7 of the third lens L3 and the object-side surface S7 of the fourth lens LA; R8 is a radius of curvature of the image-side surface S8 of the fourth lens LA; R9 is a radius of curvature of the object-side surface S9 of the fifth lens L5; R10 is a radius of curvature of the image-side surface S10 of the fifth lens L5.

Parameters of the optical imaging lens 100 of the first embodiment of the present invention are listed in following Table 1, including the focal length F of the optical imaging lens 100 (also called an effective focal length (EFL)), a F-number (Fno), a maximal field of view (FOV), a radius of curvature (R) of each lens, a distance (D) between each surface and the next surface on the optical axis Z, a refractive index (Nd) of each lens, an Abbe number (Vd) of each lens, the focal length of each lens, wherein a unit of the focal length, the radius of curvature, and the distance is millimeter (mm).

TABLE 1
Parameters of the optical imaging lens 100 of the first embodiment

| | | | | | | Cemented | | |
|---|---|---|---|---|---|---|---|---|
| | | | | | Focal | focal | Focal | |
| Surface | R(mm) | D(mm) | Nd | Vd | length | length | length | Note |
| S1 | −8.925 | 3.193 | 1.810 | 40.9929 | −20.281 | | 49.757 | First lens L1 |
| S2 | −22.541 | 2.452 | | | | | | |
| S3 | 24.388 | 2.935 | 1.651 | 55.8909 | 19.109 | | | Second lens L2 |
| S4 | −24.385 | 0.131 | | | | | | |
| S5 | INFINITY | 0.050 | | | | | | Aperture S5 |
| S6 | 11.611 | 1.273 | 1.855 | 24.8017 | −31.537 | 18.559 | 37.472 | Third lens L3 |
| S7 | 7.723 | 6.157 | 1.593 | 68.342 | 11.347 | | | Fourth lens L4 |
| S8 | −37.548 | 6.874 | | | | | | |
| S9 | −5.219 | 1.501 | 1.689 | 31.0777 | −17.491 | | | Fifth lens L5 |
| S10 | −10.238 | 1.433 | | | | | | |
| S11 | INFINITY | 0.400 | 1.517 | 64.1673 | | | | Infrared filter |
| | | | | | | | | L6 |
| S12 | INFINITY | 2.127 | | | | | | |
| S13 | INFINITY | 0.500 | 1.517 | 64.1673 | | | | Protective glass |
| | | | | | | | | L7 |
| S14 | INFINITY | 0.150 | | | | | | |
| Im | INFINITY | 0.000 | | | | | | Image plane Im |

F = 15.245 mm; Fno = 15.245; FOV = 34.7 deg

It could be seen from Table 1 that, in the first embodiment, the focal length F of the optical imaging lens 100 is 15.245 mm, and the Fno is 15.245, and the FOV is 34.7 degrees, wherein the focal length f1 of the first lens L1 is −20.281 mm; the focal length f2 of the second lens L2 is 19.109 mm; the focal length f3 of the third lens L3 is −31.537 mm; the focal length f4 of the fourth lens LA is 11.347 mm; the focal length f5 of the fifth lens L5 is −17.491 mm; a cemented focal length f34 of the compound lens formed by adhering the third lens L3 and the fourth lens L4 is 18.559 mm; the focal length fg1 of the first lens assembly G1 is 49.757 mm; the focal length fg2 of the second lens assembly G2 is 37.472 mm.

Additionally, based on the above detailed parameters, detailed values of the aforementioned conditions in the first embodiment are as follows:

$$F / ( f 1 + f 2 ) = - 1 3.015 ; \qquad ( 1 )$$

$$F / ( f 3 + f 4 + f 5 ) = - 0 \text{.407} ; \qquad ( 2 )$$

$$F / f 1 = - 0.7 \; 52 ; \qquad ( 3 )$$

$$F / f 2 = 0.798 ; \qquad ( 4 )$$

$$F / f 3 = - 0.4 \; 83 ; \qquad ( 5 )$$

$$F / f 4 = 1 \text{.344} ; \qquad ( 6 )$$

$$F / f 5 = - 0.8 \; 72 ; \qquad ( 7 )$$

$$fg 2 / ( R 1 + R 2 + R 3 + R 4 + R 6 + R 7 + R 8 + R 9 + R 10 ) = - 0.5 \; 75 ; \qquad ( 8 )$$

$$fg 2 / ( R 6 + R 7 + R 8 + R 9 + R 10 ) = - 1.1 \; 13 ; \qquad ( 9 )$$

$$fg 1 / ( R 1 + R 2 + R 3 + R 4 + R 6 + R 7 + R 8 + R 9 + R 10 ) = - 0.7 \; 64 ; \qquad ( 10 )$$

$$fg 1 / ( R 1 + R 2 + R 3 + R 4 ) = - 1.5 \; 81 ; \qquad ( 11 )$$

$$F / R 1 = - 1.7 \; 08 ; \qquad ( 12 )$$

$$F / R 2 = - 0.6 \; 76 ; \qquad ( 13 )$$

$$F / R 3 = 0 \text{.625} ; \qquad ( 14 )$$

$$F / R 4 = - 0 \text{.625} ; \qquad ( 15 )$$

$$F / R 6 = 1 \text{.313} ; \qquad ( 16 )$$

$$F / R 7 = 1 \text{.974} ; \qquad ( 17 )$$

$$F / R 8 = - 0 \text{.406} ; \qquad ( 18 )$$

$$F / R 9 = - 2 \text{.921} ; \qquad ( 19 )$$

$$F / R 10 = - 1 \text{.489} . \qquad ( 20 )$$

With the parameters from Table 1, in the first embodiment, the focal length of the first lens L1 to the fifth lens L5, the focal length fg1 of the first lens assembly G1, the focal length fg2 of the second lens assembly G2, and the radius of curvature of the first lens L1 to the fifth lens L5 satisfy the aforementioned conditions (1) to (20) of the optical imaging lens 100.

Moreover, an aspheric surface contour shape Z of each of the object-side surface S1 of the first lens L1, the image-side surface S2 of the first lens L1, the object-side surface S9 of the fifth lens L5, and the image-side surface S10 of the fifth lens L5 of the optical imaging lens 100 according to the first embodiment could be obtained by following formula:

$$Z = \frac{c {h}^{2}}{1 + 1 - ( 1 + k ) {c}^{2} {h}^{2}} + {A}_{2} {h}^{2} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A2, A4, A6, A8, A10, A12, A14, and A16 respectively represent different order coefficients of h.

The conic constants k and the different order coefficients of A2, A4, A6, A8, A10, A12, A14, and A16 of each of the aspheric surfaces of the optical imaging lens 100 according to the first embodiment are listed in following Table 2:

TABLE 2

| Surface | S1 | S2 | S9 | S10 |
|---|---|---|---|---|
| k | −4.24E−01 | −6.66E−01 | −1.84E+00 | −4.73E+00 |
| A2 | 0 | 0 | 0 | 0 |
| A4 | 1.99E−04 | 2.07E−04 | −3.62E−05 | 7.04E−04 |
| A6 | 5.11E−06 | 2.66E−06 | 5.41E−05 | 5.75E−06 |
| A8 | −3.41E−07 | −1.05E−07 | −6.73E−06 | 2.19E−06 |
| A10 | 1.68E−08 | 3.81E−09 | 3.42E−07 | −3.86E−07 |
| A12 | −3.82E−10 | −4.80E−11 | −3.61E−09 | 2.37E−08 |
| A14 | 3.09E−12 | 0 | −1.58E−10 | −5.09E−10 |
| A16 | 0 | 0 | 0 | 0 |

Taking optical simulation data to verify the imaging quality of the optical imaging lens 100, wherein FIG. 1B is a diagram showing a longitudinal chromatic aberration according to the first embodiment; FIG. 1C is a diagram showing a lateral chromatic aberration according to the first embodiment. From FIG. 1B and FIG. 1C, it could be observed that the optical imaging lens 100 could effectively enhance image quality.

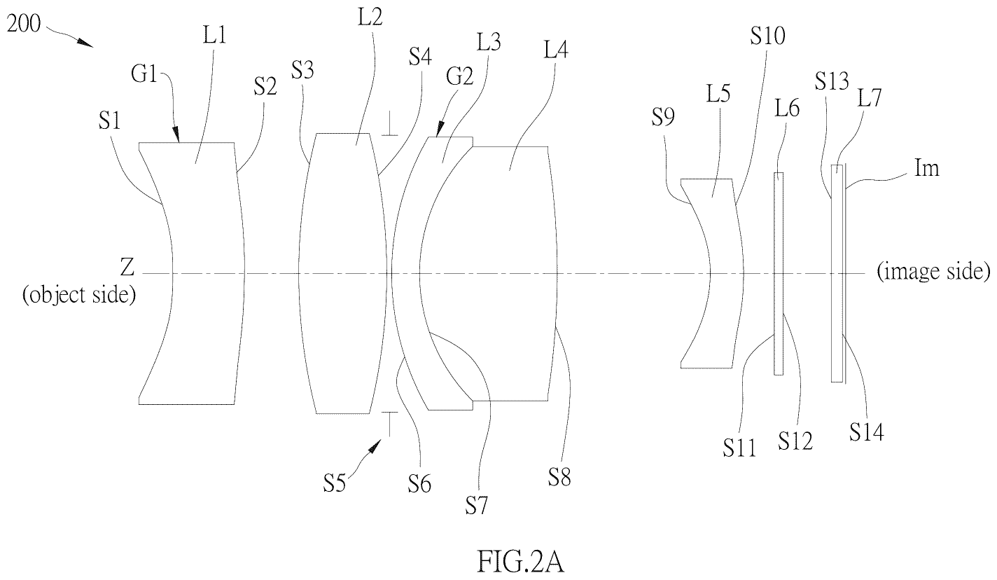

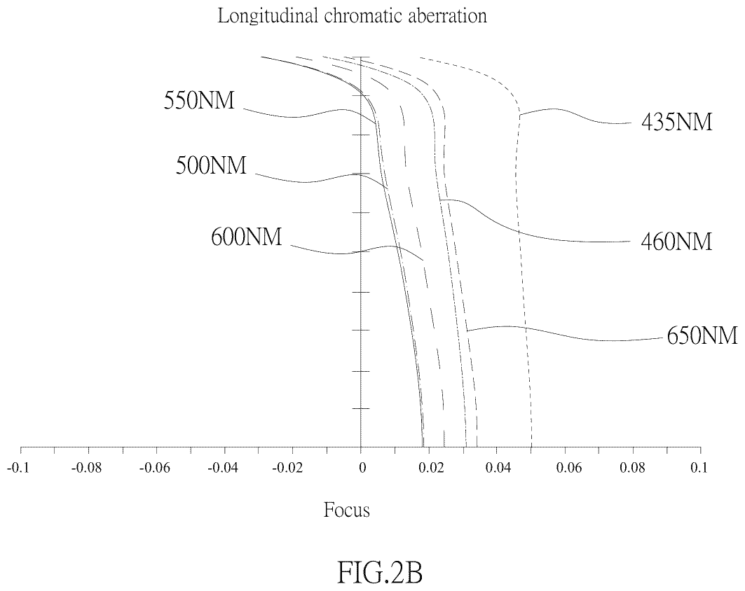

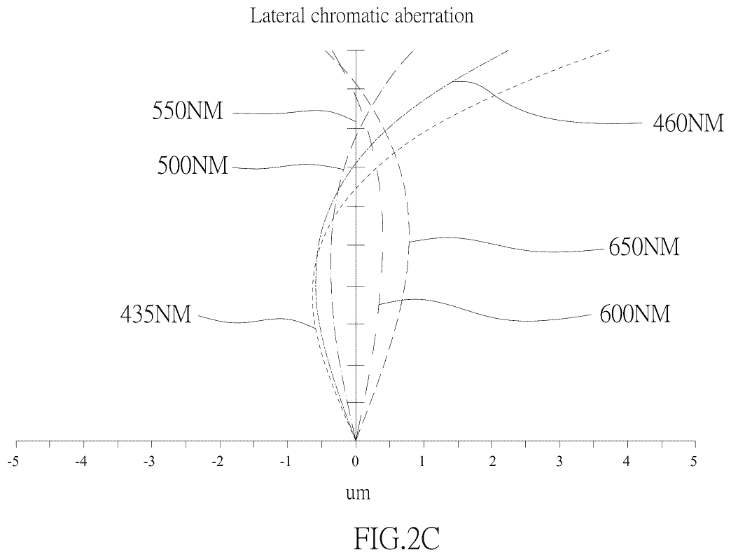

An optical imaging lens 200 according to a second embodiment of the present invention is illustrated in FIG. 2A, which includes, in order along an optical axis Z from an object side to an image side, a first lens assembly G1, an aperture S5, and a second lens assembly G2. In the second embodiment, the optical imaging lens 200 has at least five lenses, wherein the first lens assembly G1 consists of, in order along the optical axis Z from the object side to the image side, a first lens L1 and a second lens L2. The second lens assembly G2 consists of, in order along the optical axis Z from the object side to the image side, a third lens L3, a fourth lens LA, and a fifth lens L5, wherein the first lens L1, the second lens L2, and the fifth lens L5 are single lenses, which means that an air space is provided between the first lens L1 and the second lens L2 along the optical axis Z, an air space is provided between the second lens L2 and the third lens L3 along the optical axis Z, and an air space is provided between the fourth lens L4 and the fifth lens L5 along the optical axis Z. The third lens L3 and the fourth lens LA are adhered to form a compound lens.

The first lens L1 has negative refractive power. An object-side surface S1 of the first lens L1 is a concave surface. An image-side surface S2 of the first lens L1 is a convex surface. In the current embodiment, both of the object-side surface S1 of the first lens L1 and the image-side surface S2 of the first lens L1 are aspheric surfaces.

The second lens L2 is a biconvex lens with positive refractive power. In the current embodiment, both of an object-side surface S3 of the second lens L2 and an image-side surface S4 of the second lens L2 are spherical surfaces.

The third lens L3 has negative refractive power. An object-side surface S6 of the third lens L3 is a convex surface. An image-side surface S7 of the third lens L3 is a concave surface. In the current embodiment, both of the object-side surface S6 of the third lens L3 and the image-side surface S7 of the third lens L3 are spherical surfaces.

The fourth lens LA is a biconvex lens with positive refractive power. Both of an object-side surface S7 of the fourth lens LA and an image-side surface S8 of the fourth lens LA are spherical surfaces. In the current embodiment, the image-side surface S7 of the third lens L3 and the object-side surface S7 of the fourth lens LA are correspondingly adhered, so that the third lens L3 and the fourth lens LA are combined to form the compound lens with positive refractive power.

The fifth lens L5 has negative refractive power. An object-side surface S9 of the fifth lens L5 is a concave surface. An image-side surface S10 of the fifth lens L5 is a convex surface. In the current embodiment, both of the object-side surface S9 of the fifth lens L5 and the image-side surface S10 of the fifth lens L5 are aspheric surfaces.

Additionally, the optical imaging lens 200 further includes an infrared filter L6 and a protective glass L7, wherein the infrared filter L6 forms an object-side surface S11 facing the object side and an image-side surface S12 facing the image side. The infrared filter L6 is located on a side of the image-side surface S10 of the fifth lens L5, thereby restricting infrared rays passing through the optical imaging lens 200 to improve the quality and fidelity of the image. The protective glass L7 forms an object-side surface S13 facing the object side and an image-side surface S14 facing the image side. The protective glass L7 is disposed on a side of the infrared filter L6 and is located between the infrared filter L6 and an image plane Im, thereby protecting the infrared filter L6.

In order to keep the optical imaging lens 200 in good optical performance and high imaging quality, in the second embodiment, the optical imaging lens 200 further satisfies:

$$- 17.00 < F / ( f 1 + f 2 ) < - 12 \text{.00} ; \qquad ( 1 )$$

$$- 0.5 < F / ( f 3 + f 4 + f 5 ) < - 0. 30 ; \qquad ( 2 )$$

$$- 0.76 < F / f 1 < - 0.73 ; \qquad ( 3 )$$

$$0.78 \leq F / f 2 < 0.8 ; \qquad ( 4 )$$

$$- 0.49 < F / f 3 < - 0.46 ; \qquad ( 5 )$$

$$1.3 < F / f 4 < 1 \text{.35} ; \qquad ( 6 )$$

$$- 0.89 < F / f 5 < - 0.83 ; \qquad ( 7 )$$

$$- 0.8 < fg 2 / ( R 1 + R 2 + R 3 + R 4 + R 6 + R 7 + R 8 + R 9 + R 10 ) < - 0. 30 ; \qquad ( 8 )$$

$$- 1.5 < fg 2 / ( R 6 + R 7 + R 8 + R 9 + R 10 ) < - 0. 80 ; \qquad ( 9 )$$

$$- 0.8 < fg 1 / ( R 1 + R 2 + R 3 + R 4 + R 6 + R 7 + R 8 + R 9 + R 10 ) < - 0.6 ; \qquad ( 10 )$$

$$- 1.6 < fg 1 / ( R 1 + R 2 + R 3 + R 4 ) < - 1.5 ; \qquad ( 11 )$$

$$- 2. < F / R 1 < - 1.5 ; \qquad ( 12 )$$

$$- 0.8 < F / R 2 < - 0.6 ; \qquad ( 13 )$$

$$0.55 < F / R 3 < 0 \text{.65} ; \qquad ( 14 )$$

$$- 0.7 < F / R 4 < - 0.55 ; \qquad ( 15 )$$

$$1. < F / R 6 < 1 \text{.60} ; \qquad ( 16 )$$

$$1.9 < F / R 7 < 2 \text{.00} ; \qquad ( 17 )$$

$$- 0.45 < F / R 8 < - 0.35 ; \qquad ( 18 )$$

$$- 2.95 < F / R 9 < - 2 \text{.75} ; \qquad ( 19 )$$

$$- 1.5 < F / R 10 < - 1.4 ; \qquad ( 20 )$$

wherein F is a focal length of the optical imaging lens 200; f1 is a focal length of the first lens L1; f2 is a focal length of the second lens L2; f3 is a focal length of the third lens L3; f4 is a focal length of the fourth lens L4; f5 is a focal length of the fifth lens L5; fg1 is a focal length of the first lens assembly G1; fg2 is a focal length of the second lens assembly G2; R1 is a radius of curvature of the object-side surface S1 of the first lens L1; R2 is a radius of curvature of the image-side surface S2 of the first lens L1; R3 is a radius of curvature of the object-side surface S3 of the second lens L2; R4 is a radius of curvature of the image-side surface S4 of the second lens L2; R6 is a radius of curvature of the object-side surface S6 of the third lens L3; R7 is a common radius of curvature of the image-side surface S7 of the third lens L3 and the object-side surface S7 of the fourth lens L4; R8 is a radius of curvature of the image-side surface S8 of the fourth lens L4; R9 is a radius of curvature of the object-side surface S9 of the fifth lens L5; R10 is a radius of curvature of the image-side surface S10 of the fifth lens L5.

Parameters of the optical imaging lens 200 of the second embodiment of the present invention are listed in following Table 3, including the focal length F of the optical imaging lens 200 (also called an effective focal length (EFL)), a F-number (Fno), a maximal field of view (FOV), a radius of curvature (R) of each lens, a distance (D) between each surface and the next surface on the optical axis Z, a refractive index (Nd) of each lens, an Abbe number (Vd) of each lens, the focal length of each lens, wherein a unit of the focal length, the radius of curvature, and the distance is millimeter (mm).

TABLE 3
Parameters of the optical imaging lens 200 of the second embodiment

| | | | | | | Cemented | | |
|---|---|---|---|---|---|---|---|---|
| | | | | | Focal | focal | Focal | |
| Surface | R(mm) | D(mm) | Nd | Vd | length | length | length | Note |
| S1 | −8.912 | 3.194 | 1.810 | 40.993 | −20.239 | | 49.635 | First lens L1 |
| S2 | −22.530 | 2.451 | | | | | | |
| S3 | 24.490 | 3.934 | 1.651 | 55.891 | 19.305 | | | Second lens L2 |
| S4 | −24.377 | 0.130 | | | | | | |
| S5 | INFINITY | 0.050 | | | | | | Aperture S5 |
| S6 | 11.585 | 1.262 | 1.855 | 24.802 | −31.736 | 18.500 | 37.923 | Third lens L3 |
| S7 | 7.728 | 6.156 | 1.593 | 68.342 | 11.353 | | | Fourth lens L4 |
| S8 | −37.542 | 6.873 | | | | | | |
| S9 | −5.158 | 1.500 | 1.689 | 31.078 | −17.090 | | | Fifth lens L5 |
| S10 | −10.219 | 1.382 | | | | | | |
| S11 | INFINITY | 0.400 | 1.517 | 64.167 | | | | Infrared filter L6 |
| S12 | INFINITY | 2.156 | | | | | | |
| S13 | INFINITY | 0.500 | 1.517 | 64.167 | | | | Protective glass |
| | | | | | | | | L7 |
| S14 | INFINITY | 0.150 | | | | | | |
| Im | INFINITY | 0.000 | | | | | | Image plane Im |

F = 15.195 mm; Fno = 1.761; FOV = 35.039 deg

It could be seen from Table 3 that, in the second embodiment, the focal length F of the optical imaging lens 200 is 15.195 mm, and the Fno is 1.761, and the FOV is 35.039 degrees, wherein the focal length f1 of the first lens L1 is −20.239 mm; the focal length f2 of the second lens L2 is 19.305 mm; the focal length f3 of the third lens L3 is −31.736 mm; the focal length f4 of the fourth lens LA is 11.353 mm; the focal length f5 of the fifth lens L5 is −17.090 mm; a cemented focal length f34 of the compound lens formed by adhering the third lens L3 and the fourth lens LA is 18.500 mm; the focal length fg1 of the first lens assembly G1 is 49.635 mm; the focal length fg2 of the second lens assembly G2 is 37.923 mm.

Additionally, based on the above detailed parameters, detailed values of the aforementioned conditions in the second embodiment are as follows:

$$F / ( f 1 + f 2 ) = - 1 6.273 ; \qquad ( 1 )$$

$$F / ( f 3 + f 4 + f 5 ) = - 0 \text{.406} ; \qquad ( 2 )$$

$$F / f 1 = - 0 \text{.751} ; \qquad ( 3 )$$

$$F / f 2 = 0 \text{.787} ; \qquad ( 4 )$$

$$F / f 3 = - 0 \text{.479} ; \qquad ( 5 )$$

$$F / f 4 = 1.338 ; \qquad ( 6 )$$

$$F / f 5 = - 0.8 \; 89 ; \qquad ( 7 )$$

$$fg 2 / ( R 1 + R 2 + R 3 + R 4 + R 6 + R 7 + R 8 + R 9 + R 10 ) = - 0 \text{.584} ; \qquad ( 8 )$$

$$fg 2 / ( R 6 + R 7 + R 8 + R 9 + R 10 ) = - 1 \text{.128} ; \qquad ( 9 )$$

$$fg 1 / ( R 1 + R 2 + R 3 + R 4 + R 6 + R 7 + R 8 + R 9 + R 10 ) = - 0 \text{.764} ; \qquad ( 10 )$$

$$fg 1 / ( R 1 + R 2 + R 3 + R 4 ) = - 1 \text{.584} ; \qquad ( 11 )$$

$$F / R 1 = - 1 \text{.705} ; \qquad ( 12 )$$

$$F / R 2 = - 0 \text{.674} ; \qquad ( 13 )$$

$$F / R 3 = 0 \text{.620} ; \qquad ( 14$$

$$F / R 4 = - 0 \text{.623} ; \qquad ( 15 )$$

$$F / R 6 = 1 \text{.312} ; \qquad ( 16 )$$

$$F / R 7 = 1 \text{.966} ; \qquad ( 17 )$$

$$F / R 8 = - 0 \text{.405} ; \qquad ( 18 )$$

$$F / R 9 = - 2 \text{.946} ; \qquad ( 19 )$$

$$F / R 10 = - 1.487 . \qquad ( 20 )$$

With the parameters from Table 3, in the second embodiment, the focal length of the first lens L1 to the fifth lens L5, the focal length fg1 of the first lens assembly G1, the focal length fg2 of the second lens assembly G2, and the radius of curvature of the first lens L1 to the fifth lens L5 satisfy the aforementioned conditions (1) to (20) of the optical imaging lens 200.

Moreover, an aspheric surface contour shape Z of each of the object-side surface S1 of the first lens L1, the image-side surface S2 of the first lens L1, the object-side surface S9 of the fifth lens L5, and the image-side surface S10 of the fifth lens L5 of the optical imaging lens 200 according to the second embodiment could be obtained by following formula:

$$Z = \frac{c {h}^{2}}{1 + 1 - ( 1 + k ) {c}^{2} {h}^{2}} + {A}_{2} {h}^{2} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A2, A4, A6, A8, A10, A12, A14, and A16 respectively represent different order coefficients of h.

The conic constant k and the different order coefficients of A2, A4, A6, A8,A10, A12, A14, and A16 of each of the aspheric surfaces of the optical imaging lens 200 according to the second embodiment are listed in following Table 4:

TABLE 4

| Surface | S1 | S2 | S9 | S10 |
|---|---|---|---|---|
| k | −4.24E−01 | −6.66E−01 | −1.84E+00 | −4.73E+00 |
| A2 | 0 | 0 | 0 | 0 |
| A4 | 1.99E−04 | 2.07E−04 | −3.62E−05 | 7.04E−04 |
| A6 | 5.11E−06 | 2.66E−06 | 5.41E−05 | 5.75E−06 |
| A8 | −3.41E−07 | −1.05E−07 | −6.73E−06 | 2.19E−06 |
| A10 | 1.68E−08 | 3.81E−09 | 3.42E−07 | −3.86E−07 |
| A12 | −3.82E−10 | −4.80E−11 | −3.61E−09 | 2.37E−08 |
| A14 | 3.09E−12 | 0 | −1.58E−10 | −5.09E−10 |
| A16 | 0 | 0 | 0 | 0 |

Taking optical simulation data to verify the imaging quality of the optical imaging lens 200, wherein FIG. 2B is a diagram showing a longitudinal chromatic aberration according to the second embodiment; FIG. 2C is a diagram showing a lateral chromatic aberration according to the second embodiment. From FIG. 2B and FIG. 2C, it could be observed that the optical imaging lens 200 could effectively enhance image quality.

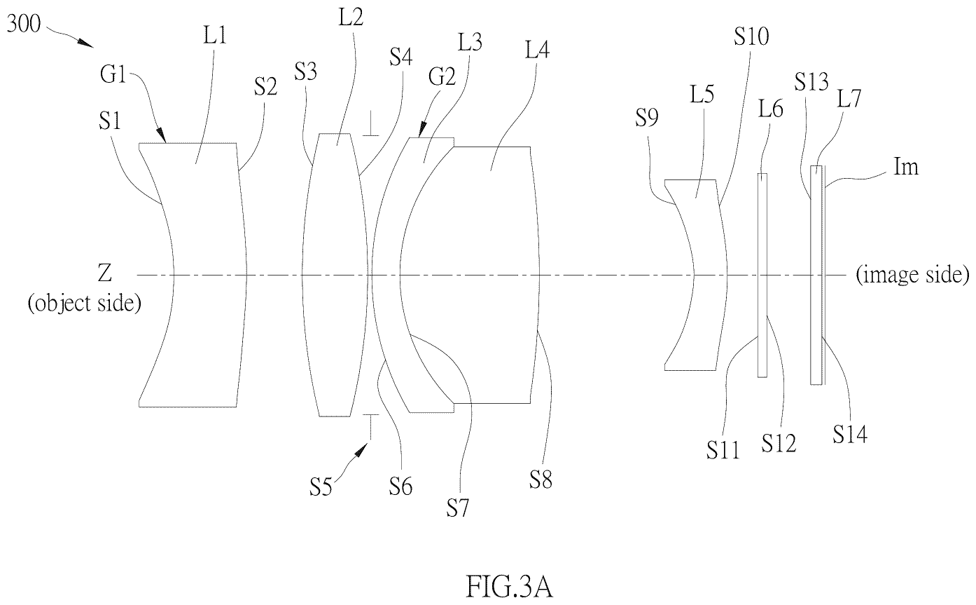

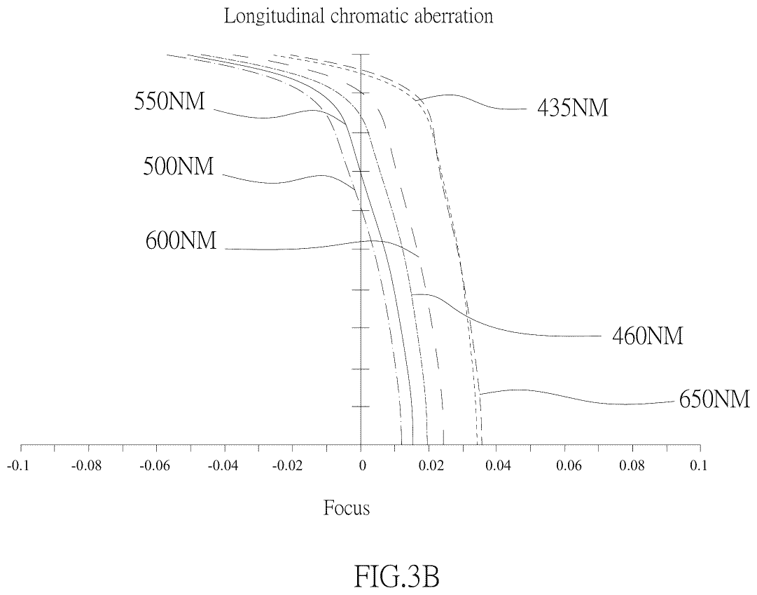

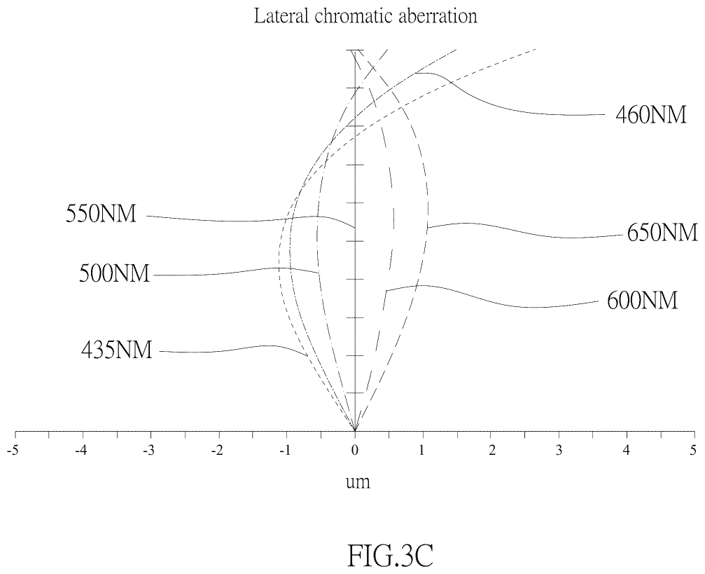

An optical imaging lens 300 according to a third embodiment of the present invention is illustrated in FIG. 3A, which includes, in order along an optical axis Z from an object side to an image side, a first lens assembly G1, an aperture S5, and a second lens assembly G2. In the third embodiment, the optical imaging lens 300 has at least five lenses, wherein the first lens assembly G1 consists of, in order along the optical axis Z from the object side to the image side, a first lens L1 and a second lens L2. The second lens assembly G2 consists of, in order along the optical axis Z from the object side to the image side, a third lens L3, a fourth lens LA, and a fifth lens L5, wherein the first lens L1, the second lens L2, and the fifth lens L5 are single lenses, which means that an air space is provided between the first lens L1 and the second lens L2 along the optical axis Z, an air space is provided between the second lens L2 and the third lens L3 along the optical axis Z, and an air space is provided between the fourth lens LA and the fifth lens L5 along the optical axis Z. The third lens L3 and the fourth lens LA are adhered to form a compound lens.

The first lens L1 has negative refractive power. An object-side surface S1 of the first lens L1 is a concave surface. An image-side surface S2 of the first lens L1 is a convex surface. In the current embodiment, both of the object-side surface S1 of the first lens L1 and the image-side surface S2 of the first lens L1 are aspheric surfaces.

The second lens L2 is a biconvex lens with positive refractive power. In the current embodiment, both of an object-side surface S3 of the second lens L2 and an image-side surface S4 of the second lens L2 are spherical surfaces.

The third lens L3 has negative refractive power. An object-side surface S6 of the third lens L3 is a convex surface. An image-side surface S7 of the third lens L3 is a concave surface. In the current embodiment, both of the object-side surface S6 of the third lens L3 and the image-side surface S7 of the third lens L3 are spherical surfaces.

The fourth lens LA is a biconvex lens with positive refractive power. Both of an object-side surface S7 of the fourth lens LA and an image-side surface S8 of the fourth lens LA are spherical surfaces. In the current embodiment, the image-side surface S7 of the third lens L3 and the object-side surface S7 of the fourth lens LA are correspondingly adhered, so that the third lens L3 and the fourth lens LA are combined to form the compound lens with positive refractive power.

The fifth lens L5 has negative refractive power. An object-side surface S9 of the fifth lens L5 is a concave surface. An image-side surface S10 of the fifth lens L5 is a convex surface. In the current embodiment, both of the object-side surface S9 of the fifth lens L5 and the image-side surface S10 of the fifth lens L5 are aspheric surfaces.

Additionally, the optical imaging lens 300 further includes an infrared filter L6 and a protective glass L7, wherein the infrared filter L6 forms an object-side surface S11 facing the object side and an image-side surface S12 facing the image side. The infrared filter L6 is located on a side of the image-side surface S10 of the fifth lens L5, thereby restricting infrared rays passing through the optical imaging lens 300 to improve the quality and fidelity of the image. The protective glass L7 forms an object-side surface S13 facing the object side and an image-side surface S14 facing the image side. The protective glass L7 is disposed on a side of the infrared filter L6 and is located between the infrared filter L6 and an image plane Im, thereby protecting the infrared filter L6.

In order to keep the optical imaging lens 300 in good optical performance and high imaging quality, in the third embodiment, the optical imaging lens 300 further satisfies:

$$- 17. 00 < F / ( f 1 + f2 ) < - 12 \text{.00} ; \qquad ( 1 )$$

$$- 0.5 < F / ( f 3 + f 4 + f5 ) < - 0.3 ; \qquad ( 2 )$$

$$- 0.76 < F / f 1 < - 0.73 ; \qquad ( 3 )$$

$$0.78 \leq F / f 2 < 0.8 ; \qquad ( 4 )$$

$$- 0.49 < F / f 3 < - 0.46 ; \qquad ( 5 )$$

$$1.3 < F / f 4 < 1 \text{.35} ; \qquad ( 6 )$$

$$- 0.89 < F / f5 < - 0.83 ; \qquad ( 7 )$$

$$- 0.8 < fg 2 / ( R 1 + R 2 + R 3 + R 4 + R 6 + R 7 + R 8 + R 9 + R 10 ) < - 0. 30 ; \qquad ( 8 )$$

$$- 1.5 < fg 2 / ( R 6 + R 7 + R 8 + R 9 + R 10 ) < - 0.8 ; \qquad ( 9 )$$

$$- 0.8 < fg 1 / ( R 1 + R 2 + R 3 + R 4 + R 6 + R 7 + R 8 + R 9 + R 10 ) < - 0. 60 ; \qquad ( 10 )$$

$$- 1.6 < fg 1 / ( R 1 + R 2 + R 3 + R 4 ) < - 1.5 ; \qquad ( 11 )$$

$$- 2. < F / R 1 < - 1.5 ; \qquad ( 12 )$$

$$- 0.8 < F / R 2 < - 0.6 ; \qquad ( 13 )$$

$$0.55 < F / R 3 < 0 \text{.65} ; \qquad ( 14 )$$

$$- 0.7 < F / R 4 < - 0.55 ; \qquad ( 15 )$$

$$1. < F / R 6 < 1 \text{.60} ; \qquad ( 16 )$$

$$1.9 < F / R 7 < 2 \text{.00} ; \qquad ( 17 )$$

$$- 0.45 < F / R 8 < - 0.35 ; \qquad ( 18 )$$

$$- 2.95 < F / R 9 < - 2.75 ; \qquad ( 19 )$$

$$- 1.5 < F / R 10 < - 1.4 ; \qquad ( 20 )$$

wherein F is a focal length of the optical imaging lens 300; f1 is a focal length of the first lens L1; f2 is a focal length of the second lens L2; f3 is a focal length of the third lens L3; f4 is a focal length of the fourth lens LA; f5 is a focal length of the fifth lens L5; fg1 is a focal length of the first lens assembly G1; fg2 is a focal length of the second lens assembly G2; R1 is a radius of curvature of the object-side surface S1 of the first lens L1; R2 is a radius of curvature of the image-side surface S2 of the first lens L1; R3 is a radius of curvature of the object-side surface S3 of the second lens L2; R4 is a radius of curvature of the image-side surface S4 of the second lens L2; R6 is a radius of curvature of the object-side surface S6 of the third lens L3; R7 is a common radius of curvature of the image-side surface S7 of the third lens L3 and the object-side surface S7 of the fourth lens L4; R8 is a radius of curvature of the image-side surface S8 of the fourth lens LA; R9 is a radius of curvature of the object-side surface S9 of the fifth lens L5; R10 is a radius of curvature of the image-side surface S10 of the fifth lens L5.

Parameters of the optical imaging lens 300 of the third embodiment of the present invention are listed in following Table 5, including the focal length F of the optical imaging lens 300 (also called an effective focal length (EFL)), a F-number (Fno), a maximal field of view (FOV), a radius of curvature (R) of each lens, a distance (D) between each surface and the next surface on the optical axis Z, a refractive index (Nd) of each lens, an Abbe number (Vd) of each lens, the focal length of each lens, wherein a unit of the focal length, the radius of curvature, and the distance is millimeter (mm).

TABLE 5
Parameters of the optical imaging lens 300 of the third embodiment

| | | | | | | Cemented | | |
|---|---|---|---|---|---|---|---|---|
| | | | | | Focal | focal | Focal | |
| Surface | R(mm) | D(mm) | Nd | Vd | length | length | length | Note |
| S1 | −8.927 | 3.242 | 1.810 | 40.9929 | −20.328 | | 49.182 | First lens L1 |
| S2 | −22.537 | 2.456 | | | | | | |
| S3 | 24.385 | 2.934 | 1.651 | 55.8909 | 19.109 | | | Second lens L2 |
| S4 | −24.386 | 0.130 | | | | | | |
| S5 | INFINITY | 0.050 | | | | | | Aperture S5 |
| S6 | 11.581 | 1.262 | 1.855 | 24.8017 | −32.323 | 18.438 | 36.038 | Third lens L3 |
| S7 | 7.768 | 6.156 | 1.593 | 68.342 | 11.401 | | | Fourth lens L4 |
| S8 | −37.547 | 6.873 | | | | | | |
| S9 | −5.273 | 1.500 | 1.689 | 31.0777 | −17.888 | | | Fifth lens L5 |
| S10 | −10.239 | 1.363 | | | | | | |
| S11 | INFINITY | 0.400 | 1.517 | 64.1673 | | | | Infrared filter L6 |
| S12 | INFINITY | 1.949 | | | | | | |
| S13 | INFINITY | 0.500 | 1.517 | 64.1673 | | | | Protective glass |
| | | | | | | | | L7 |
| S14 | INFINITY | 0.150 | | | | | | |
| Im | INFINITY | 0.000 | | | | | | Image plane Im |

F = 14.905 mm; Fno = 1.712; FOV = 35.6 deg

It could be seen from Table 5 that, in the third embodiment, the focal length F of the optical imaging lens 300 is 14.905 mm, and the Fno is 1.712, and the FOV is 35.6degrees, wherein the focal length f1 of the first lens L1 is −20.328 mm; the focal length f2 of the second lens L2 is 19.109 mm; the focal length f3 of the third lens L3 is −32.323 mm; the focal length f4 of the fourth lens LA is 11.401 mm; the focal length f5 of the fifth lens L5 is −17.888 mm; a cemented focal length f34 of the compound lens formed by adhering the third lens L3 and the fourth lens LA is 18.438 mm; the focal length fg1 of the first lens assembly G1 is 49.182 mm; the focal length fg2 of the second lens assembly G2 is 36.03 8mm.

Additionally, based on the above detailed parameters, detailed values of the aforementioned conditions in the third embodiment are as follows:

$$F / ( f 1 + f 2 ) = - 1 2.218 ; \qquad ( 1 )$$

$$F / ( f 3 + f 4 + f 5 ) = - 0 \text{.384} ; \qquad ( 2 )$$

$$F / f 1 = - 0 \text{.733} ; \qquad ( 3 )$$

$$F / f 2 = 0 \text{.780} ; \qquad ( 4 )$$

$$F / f 3 = - 0 \text{.461} ; \qquad ( 5 )$$

$$F / f 4 = 1.307 ; \qquad ( 6 )$$

$$F / f 5 = - 0 \text{.833} ; \qquad ( 7 )$$

$$fg 2 / ( R 1 + R 2 + R 3 + R 4 + R 6 + R 7 + R 8 + R 9 + R 10 ) = - 0 \text{.553} ; \qquad ( 8 )$$

$$fg 2 / ( R 6 + R 7 + R 8 + R 9 + R 10 ) = - 1 \text{.069} ; \qquad ( 9 )$$

$$fg 1 / ( R 1 + R 2 + R 3 + R 4 + R 6 + R 7 + R 8 + R 9 + R 10 ) = - 0 \text{.755} ; \qquad ( 10 )$$

$$fg 1 / ( R 1 + R 2 + R 3 + R 4 ) = - 1 \text{.563} ; \qquad ( 11 )$$

$$F / R 1 = - 1 \text{.670} ; \qquad ( 12 )$$

$$F / R 2 = - 0 \text{.661} ; \qquad ( 13 )$$

$$F / R 3 = 0 \text{.611} ; \qquad ( 14 )$$

$$F / R 4 = - 0 \text{.611} ; \qquad ( 15 )$$

$$F / R 6 = 1 \text{.287} ; \qquad ( 16 )$$

$$F / R 7 = 1 \text{.919} ; \qquad ( 17 )$$

$$F / R 8 = - 0 \text{.397} ; \qquad ( 18 )$$

$$F / R 9 = - 2 \text{.827} ; \qquad ( 19 )$$

$$F / R 10 = - 1.456 . \qquad ( 20 )$$

With the parameters from Table 5, in the third embodiment, the focal length of the first lens L1 to the fifth lens L5, the focal length fg1 of the first lens assembly G1, the focal length fg2 of the second lens assembly G2, and the radius of curvature of the first lens L1 to the fifth lens L5 satisfy the aforementioned conditions (1) to (20) of the optical imaging lens 300.

Moreover, an aspheric surface contour shape Z of each of the object-side surface S1 of the first lens L1, the image-side surface S2 of the first lens L1, the object-side surface S9 of the fifth lens L5, and the image-side surface S10 of the fifth lens L5 of the optical imaging lens 300 according to the third embodiment could be obtained by following formula:

$$Z = \frac{{ch}^{2}}{1 + 1 - ( 1 + k ) {c}^{2} {h}^{2}} + {A}_{2} {h}^{2} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A2, A4, A6, A8, A10, A12, A14, and A16 respectively represent different order coefficients of h.

The conic constant k and the different order coefficients of A2, A4, A6, A8, A10, A12, A14, and A16 of each of the aspheric surfaces of the optical imaging lens 300 according to the third embodiment are listed in following Table 6:

TABLE 6

| Surface | S1 | S2 | S9 | S10 |
|---|---|---|---|---|
| k | −4.24E−01 | −6.66E−01 | −1.84E+00 | −4.73E+00 |
| A2 | 0 | 0 | 0 | 0 |
| A4 | 1.99E−04 | 2.07E−04 | −3.62E−05 | 7.04E−04 |
| A6 | 5.11E−06 | 2.66E−06 | 5.41E−05 | 5.75E−06 |
| A8 | −3.41E−07 | −1.05E−07 | −6.73E−06 | 2.19E−06 |
| A10 | 1.68E−08 | 3.81E−09 | 3.42E−07 | −3.86E−07 |
| A12 | −3.82E−10 | −4.80E−11 | −3.61E−09 | 2.37E−08 |
| A14 | 3.09E−12 | 0 | −1.58E−10 | −5.09E−10 |
| A16 | 0 | 0 | 0 | 0 |

Taking optical simulation data to verify the imaging quality of the optical imaging lens 300, wherein FIG. 3B is a diagram showing a longitudinal chromatic aberration according to the third embodiment; FIG. 3C is a diagram showing a lateral chromatic aberration according to the third embodiment. From FIG. 3B and FIG. 3C, it could be observed that the optical imaging lens 300 could effectively enhance image quality.

It must be pointed out that the embodiments described above are only some preferred embodiments of the present invention. It is noted that, the parameters listed in Tables are not a limitation of the present invention. All equivalent structures which employ the concepts disclosed in this specification and the appended claims should fall within the scope of the present invention.

What is claimed is:

1. An optical imaging lens, in order from an object side to an image side along an optical axis, comprising:
a first lens assembly consisting of, in order from the object side to the image side along the optical axis, a first lens and a second lens, wherein the first lens has negative refractive power; an object-side surface of the first lens is a concave surface; an image-side surface of the first lens is a convex surface; the second lens has positive refractive power;
an aperture; and
a second lens assembly consisting of, in order from the object side to the image side along the optical axis, a third lens, a fourth lens, and a fifth lens, wherein the third lens has negative refractive power; the fourth lens has positive refractive power; the fifth lens has negative refractive power; an object-side surface of the fifth lens is a concave surface; an image-side surface of the fifth lens is a convex surface.

2. The optical imaging lens as claimed in claim 1, wherein an image-side surface of the third lens and an object-side surface of the fourth lens are correspondingly adhered to form a compound lens with positive refractive power; an air space is provided between the first lens and the second lens along the optical axis, an air space is provided between the second lens and the third lens along the optical axis, and an air space is provided between the fourth lens and the fifth lens along the optical axis.

3. The optical imaging lens as claimed in claim 1, wherein the second lens is a biconvex lens; an object-side surface of the third lens is a convex surface; an image-side surface of the third lens is a concave surface; the fourth lens is a biconvex lens.

4. The optical imaging lens as claimed in claim 1, wherein both of the object-side surface of the first lens and the image-side surface of the first lens are aspheric surfaces; both of an object-side surface of the second lens and an image-side surface of the second lens are spherical surfaces; both of an object-side surface of the third lens and an image-side surface of the third lens are spherical surfaces; both of an object-side surface of the fourth lens and an image-side surface of the fourth lens are spherical surfaces; both of the object-side surface of the fifth lens and the image-side surface of the fifth lens are aspheric surfaces.

5. The optical imaging lens as claimed in claim 1, wherein the optical imaging lens satisfies: −17.00<F/(f1+f2)<−12.00; F is a focal length of the optical imaging lens; f1 is a focal length of the first lens; f2 is a focal length of the second lens.

6. The optical imaging lens as claimed in claim 1, wherein the optical imaging lens satisfies: −0.50<F/(f3+f4+f5)<−0.30; F is a focal length of the optical imaging lens; f3 is a focal length of the third lens; f4 is a focal length of the fourth lens; f5 is a focal length of the fifth lens.

7. The optical imaging lens as claimed in claim 1, wherein the optical imaging lens satisfies: −0.76<F/f1<−0.73; F is a focal length of the optical imaging lens; f1 is a focal length of the first lens.

8. The optical imaging lens as claimed in claim 1, wherein the optical imaging lens satisfies: 0.78≤F/f2<0.8; F is a focal length of the optical imaging lens; f2 is a focal length of the second lens.

9. The optical imaging lens as claimed in claim 1, wherein the optical imaging lens satisfies: −0.49<F/f3 <0.46; F is a focal length of the optical imaging lens; f3 is a focal length of the third lens.

10. The optical imaging lens as claimed in claim 1, wherein the optical imaging lens satisfies: 1.30<F/f4<1.35; F is a focal length of the optical imaging lens; f4 is a focal length of the fourth lens.

11. The optical imaging lens as claimed in claim 1, wherein the optical imaging lens satisfies: −0.89<F/f5<−0.83; F is a focal length of the optical imaging lens; f5 is a focal length of the fifth lens.

12. The optical imaging lens as claimed in claim 1, wherein the optical imaging lens satisfies: −0.80<fg2/(R1+R2+R3+R4+R6+R7+R8+R9+R10)<−0.30; fg2 is a focal length of the second lens assembly; R1 is a radius of curvature of the object-side surface of the first lens; R2 is a radius of curvature of the image-side surface of the first lens; R3 is a radius of curvature of an object-side surface of the second lens; R4 is a radius of curvature of an image-side surface of the second lens; R6 is a radius of curvature of an object-side surface of the third lens; R7 is a common radius of curvature of an image-side surface of the third lens and an object-side surface of the fourth lens; R8 is a radius of curvature of an image-side surface of the fourth lens; R9 is a radius of curvature of the object-side surface of the fifth lens; R10 is a radius of curvature of the image-side surface of the fifth lens.

13. The optical imaging lens as claimed in claim 1, wherein the optical imaging lens satisfies: −1.50<fg2/(R6+R7+R8+R9+R10)<−0.80; fg2 is a focal length of the second lens assembly; R6 is a radius of curvature of an object-side surface of the third lens; R7 is a common radius of curvature of an image-side surface of the third lens and an object-side surface of the fourth lens; R8 is a radius of curvature of an image-side surface of the fourth lens; R9 is a radius of curvature of the object-side surface of the fifth lens; R10 is a radius of curvature of the image-side surface of the fifth lens.

14. The optical imaging lens as claimed in claim 1, wherein the optical imaging lens satisfies: −0.80<fg1/(R1+R2+R3+R4+R6+R7+R8+R9+R10)<−0.60; fg1 is a focal length of the first lens assembly; R1 is a radius of curvature of the object-side surface of the first lens;
R2 is a radius of curvature of the image-side surface of the first lens; R3 is a radius of curvature of an object-side surface of the second lens; R4 is a radius of curvature of an image-side surface of the second lens; R6 is a radius of curvature of an object-side surface of the third lens; R7 is a common radius of curvature of an image-side surface of the third lens and an object-side surface of the fourth lens; R8 is a radius of curvature of an image-side surface of the fourth lens; R9 is a radius of curvature of the object-side surface of the fifth lens; R10 is a radius of curvature of the image-side surface of the fifth lens.

15. The optical imaging lens as claimed in claim 1, wherein the optical imaging lens satisfies: −1.60<fg1/(R1+R2+R3+R4)<−1.50; fg1 is a focal length of the first lens assembly;
R1 is a radius of curvature of the object-side surface of the first lens; R2 is a radius of curvature of the image-side surface of the first lens; R3 is a radius of curvature of an object-side surface of the second lens; R4 is a radius of curvature of an image-side surface of the second lens.

16. The optical imaging lens as claimed in claim 1, wherein the optical imaging lens satisfies: −2.00<F/R1<−1.50; F is a focal length of the optical imaging lens; R1 is a radius of curvature of the object-side surface of the first lens.

17. The optical imaging lens as claimed in claim 1, wherein the optical imaging lens satisfies: −0.80<F/R2<−0.60; F is a focal length of the optical imaging lens; R2 is a radius of curvature of the image-side surface of the first lens.

18. The optical imaging lens as claimed in claim 1, wherein the optical imaging lens satisfies: 0.55<F/R3<0.65; F is a focal length of the optical imaging lens; R3 is a radius of curvature of an object-side surface of the second lens.

19. The optical imaging lens as claimed in claim 1, wherein the optical imaging lens satisfies: −0.70<F/R4<−0.55; F is a focal length of the optical imaging lens; R4 is a radius of curvature of an image-side surface of the second lens.

20. The optical imaging lens as claimed in claim 1, wherein the optical imaging lens satisfies: 1.00<F/R6<1.60; F is a focal length of the optical imaging lens; R6 is a radius of curvature of an object-side surface of the third lens.

21. The optical imaging lens as claimed in claim 1, wherein the optical imaging lens satisfies: 1.90<F/R7<2.00; F is a focal length of the optical imaging lens; R7 is a common radius of curvature of an image-side surface of the third lens and an object-side surface of the fourth lens.

22. The optical imaging lens as claimed in claim 1, wherein the optical imaging lens satisfies: −0.45<F/R8<−0.35; F is a focal length of the optical imaging lens; R8 is a radius of curvature of an image-side surface of the fourth lens.

23. The optical imaging lens as claimed in claim 1, wherein the optical imaging lens satisfies: −2.95<F/R9<−2.75; F is a focal length of the optical imaging lens; R9 is a radius of curvature of the object-side surface of the fifth lens.

24. The optical imaging lens as claimed in claim 1, wherein the optical imaging lens satisfies: −1.50<F/R10<−1.40; F is a focal length of the optical imaging lens; R10 is a radius of curvature of the image-side surface of the fifth lens.
